(19) United States
(12) Patent Application Publication
(10) Pub. No.: US 2024/0004157 A1
(43) Pub. Date: Jan. 4, 2024

(54) FIBER OPTIC SPLICE ORGANIZER

(71) Applicant: CommScope Technologies LLC, Hickory, NC (US)

(72) Inventors: Johan GEENS, Bunsbeek (BE); Pieter VERMEULEN, Westerlo (BE); Bart VOS, Geel (BE); Bart Mattie CLAESSENS, Hasselt (BE)

(73) Assignee: CommScope Technologies LLC, Hickory, NC (US)

(21) Appl. No.: 18/247,429

(22) PCT Filed: Sep. 30, 2021
(86) PCT No.: PCT/US2021/052942

§ 371 Date: Mar. 30, 2023

Related U.S. Application Data
(60) Provisional application No. 63/085,558, filed on Sep. 30, 2020.
(60) Provisional application No. 63/160,150, filed on Mar. 12, 2021.

(51) Int. Cl. G02B 6/44

(52) U.S. Cl. CPC G02B 6/4455; G02B 6/4454

(57) ABSTRACT

A fiber optic splice organizer includes a mounting bracket, and at least one tray of a first type attached to the mounting bracket. The first type of tray has a first length and an interior volume for storing fiber optic splices. At least one tray of a second type is attached to the mounting bracket. The second type of tray has a second length and an interior volume for storing a different quantity of fiber optic splices than the first type of tray. A modular extension is attachable to the first or second types of trays to increase their respective lengths.

### CROSS-REFERENCE TO RELATED APPLICATIONS

This application is being filed on Sep. 30, 2021 as a PCT International patent application and claims the benefit of U.S. Patent Application Ser. No. 63/085,558, filed on Sep. 30, 2020, and claims the benefit of U.S. Patent Application Ser. No. 63/160,150, filed on Mar. 12, 2021, the disclosures of which are incorporated herein by reference in their entireties.

### BACKGROUND

Fiber optic telecommunications systems are ubiquitous because of their large information carrying capacity, their virtually noise-free performance, and their ability to carry signals over long distances. Typically, one or more drop locations are included along a fiber optic cable route to deliver fiber optic connectivity to customer locations.

Each drop location or splice point requires the protection of the cable ends and individual splices. Typically, a splice enclosure is provided for terminating the cables and storing the splices. Enclosures for protecting optical fiber splices typically include one or more splice trays on which the individual splices and associated cable slack are mounted.

### SUMMARY

In general terms, the present disclosure relates to the storage and organization of fiber optic splices and equipment. In one possible configuration, a fiber optic splice organizer includes a plurality of trays of different sizes for storing fiber optic splices. Various aspects are described in this disclosure, which include, but are not limited to, the following aspects.

One aspect relates to a fiber optic splice organizer comprising a mounting bracket; at least one tray of a first type attached to the mounting bracket, the first type of tray having a first length and an interior volume for storing fiber optic splices; and at least one tray of a second type attached to the mounting bracket, the second type of tray including: a base having a second length extending from a proximal end to a distal end, the proximal end of the base being pivotally attached to the mounting bracket by a hinge, and the base having a width extending between first and second lateral sides of the base; and a sidewall at least partially surrounding the first and second lateral sides and the distal end, the sidewall and the base defining an interior volume for storing fiber optic splices; and wherein the first length of the first type of tray is longer than the second length of the second type of tray, and the interior volume of the first type of tray stores a larger quantity of fiber optic splices than the interior volume of the second type of tray; and wherein the first and second types of trays are pivotally moveable between a stacked position and an unstacked position to provide access to the fiber optic splices stored on the first and second types of trays, respectively.

Another aspect relates to a fiber optic splice organizer comprising: a tray configured for attachment to a mounting bracket and to pivotally move between a stacked position and an unstacked position, the tray including: a base having a first length extending from a proximal end to a distal end, the proximal end of the base being pivotally attached to the mounting bracket by a hinge, and the base further having a width extending between first and second lateral sides of the base; and a sidewall at least partially surrounding the first and second lateral sides and the distal end, the sidewall and the base defining an interior volume for storing fiber optic splices; and a modular extension attached to the distal end of the tray to extend the length of the tray, the modular extension providing a storage area for storing fiber optic equipment.

Another aspect relates to a fiber optic splice tray comprising: a base having a length extending from a proximal end to a distal end, and further having a width extending between first and second lateral sides of the base; a sidewall at least partially surrounding the first and second lateral sides and the distal end, the sidewall and the base defining an interior volume for storing fiber optic splices; and a label area provided on the sidewall at the distal end of the tray, the label area defining a slot for receiving a label, the slot having one or more friction retention members to retain the label inside the slot as the tray pivots between stacked and unstacked positions.

Another aspect relates to a fiber optic splice organizer comprising: a tray configured for attachment to a mounting bracket and to pivotally move between a stacked position and an unstacked position, the tray including: a base having a length extending from a proximal end to a distal end, and further having a width extending between first and second lateral sides of the base; and a sidewall at least partially surrounding the first and second lateral sides and the distal end, the sidewall and the base defining an interior volume for storing fiber optic splices; and a modular extension attached to the sidewall at the distal end of the tray to extend the length of the tray, the modular extension having a storage area for storing fiber optic equipment, and the storage area including a platform having a first row of adapters on a first side, and the platform having a second row of adapters on a second side, and the platform being pivotable about the first and second sides to provide access to the first and second rows of adapters.

Another aspect relates to a fiber optic splice tray comprising: a base having a length extending from a proximal end to a distal end, and further having a width extending between the first and second lateral sides of the base; a hinge attached to the proximal end of the base, the hinge being configured to pivotally attach the tray to a mounting bracket between stacked and unstacked positions; a sidewall at least partially surrounding the first and second lateral sides and the distal end of the base, the sidewall and the base defining an interior volume for storing fiber optic splices; and a label area provided on the hinge of the tray.

Another aspect relates to a fiber optic splice tray comprising: a base having a length extending from a proximal end to a distal end, and further having a width extending between first and second lateral sides of the base; a sidewall at least partially surrounding the first and second lateral sides and the distal end of the base, the sidewall and the base defining an interior volume for storing fiber optic splices; and a cover that encloses the interior volume, wherein the cover blocks access to the interior volume when in a closed position and allows access to the interior volume when in a stowed position, and wherein the cover when in the stowed position is held parallel to a bottom surface of the tray and is prevented from becoming detached from the tray.

### DESCRIPTION OF THE FIGURES

The following drawing figures, which form a part of this application, are illustrative of the described technology and are not meant to limit the scope of the disclosure in any manner.

FIG. 1 is a sectional, isometric view of a fiber optic splice organizer positioned within an enclosure, the fiber optic splice organizer including a plurality of trays pivotally attached to a bracket, the plurality of trays are shown in a stacked position.

FIG. 2 is a side view of the fiber optic splice organizer of FIG. 1.

FIG. 3 is a front view of the fiber optic splice organizer of FIG. 1.

FIG. 4 is an isometric view of the fiber optic splice organizer showing a first tray of a first type pivoted in an unstacked position, and exposing a first tray of a second type nested within a space defined by another tray of the second type and a modular extension.

FIG. 5 is an isometric view of the fiber optic splice organizer showing the first tray of the first type and the first tray of the second type in the unstacked position, and exposing a second tray of the second type attached to a modular extension.

FIG. 6 is an isometric view of the fiber optic splice organizer showing the first tray of the first type and the first and second trays of the second type in the unstacked position, and exposing a second tray of the first type in the stacked position.

FIG. 7 is an isometric view of an example tray.

FIG. 8 is a top view of the tray of FIG. 7.

FIG. 9 is a proximal end view of the tray of FIG. 7.

FIG. 10 is an isometric view of the tray of FIG. 7 showing a panel of a cover of the tray partially rotated from a closed position to a stowed position.

FIG. 11 is an isometric view of the tray of FIG. 7 showing the panel of FIG. 10 in the stowed position such that the panel faces a bottom surface of the tray.

FIG. 12 is a proximal end view of the tray of FIG. 7 showing one panel in the stowed position, and another panel partially rotated from the closed position to the stowed position.

FIG. 13 is a bottom, isometric view of the tray of FIG. 7 with both panels in the stowed position, and facing the bottom surface of the tray.

FIG. 14 is a detailed view of channels defined by attachment members on the tray of FIG. 7 where the panels of the cover rotate between the closed and stowed positions.

FIG. 15 is a top view of the tray of FIG. 7 with both panels in the stowed position.

FIG. 16 is a partial, isometric view of a distal end of the tray of FIG. 7.

FIG. 17 is an isometric view of a proximal end of a modular extension.

FIG. 18 is an isometric view of the proximal end of the modular extension of FIG. 17 showing a storage area of the modular extension that includes a platform having first and second rows of adapters, and with the first row of adapters being pivoted upwards.

FIG. 19 is an isometric view of the proximal end of the modular extension of FIG. 17 showing the second row of adapters of the platform being pivoted upwards.

FIG. 20 is a top view of the modular extension of FIG. 17.

FIG. 21 is a forward, isometric view of the distal end of the tray of FIG. 7 with the modular extension of FIG. 17 attached thereto.

FIG. 22 is a rearward, isometric view of the distal end of the tray of FIG. 7 with the modular extension of FIG. 17 attached thereto.

FIG. 23 is a side view of the modular extension of FIG. 17.

FIG. 24 is an exploded view of the tray of FIG. 7 and modular extension of FIG. 17.

FIG. 25 is a detailed view of a label area on the tray of FIG. 7.

FIG. 26 is an isometric view of another example of a modular extension attached to a tray that can pivotally attach to the bracket of the fiber optic splice organizer of FIG. 1.

FIG. 27 is an exploded isometric view of the modular extension and tray of FIG. 26.

FIG. 28 is a side view of the modular extension and tray of FIG. 26.

FIG. 29 is a top view of the modular extension of FIG. 26 with a cover removed therefrom, exposing a splitter having at least one splitter input and a plurality of splitter outputs.

FIG. 30 is a top view of the modular extension and tray of FIG. 26 with the cover attached to the modular extension, and showing the splitter input and outputs organized by cable managers on the tray.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

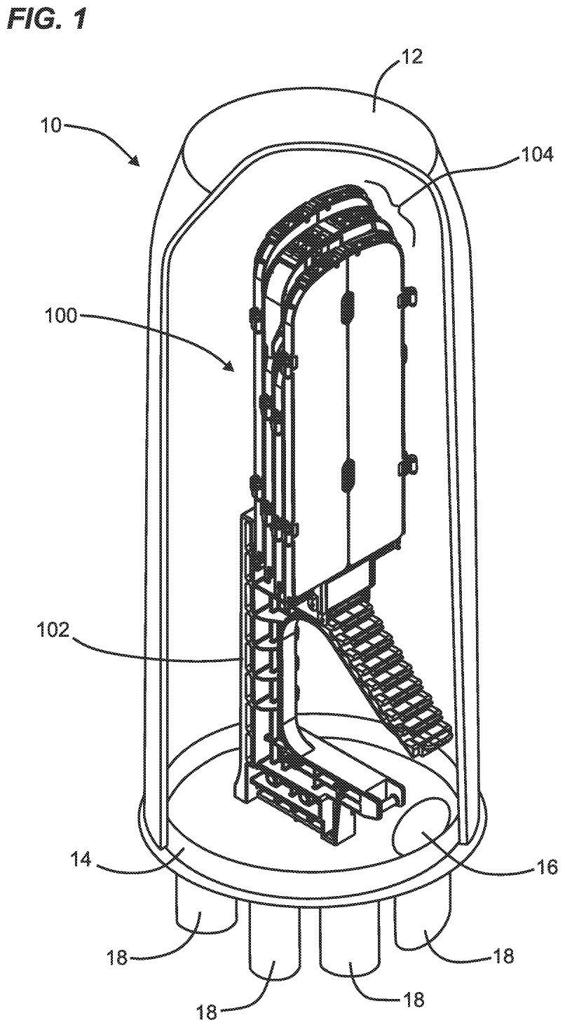

FIG. 1 is a sectional, isometric view of a splice organizer 100 positioned inside an enclosure 10. The enclosure 10 includes a protective housing 12 attached to an end cap 14, and that together with the end cap 14 defines an interior volume 20. In the example shown in FIG. 1, the protective housing 12 has a substantially dome shape.

A mounting bracket 102 secures the splice organizer 100 to the end cap 14. Fiber optic cables enter the enclosure 10 through one or more cable ports 18 that extend from an exterior surface of the end cap 14, and through one or more openings 16 on an interior surface of the end cap 14 that provide access to the interior volume 20.

A plurality of trays 104 are pivotally attached to the mounting bracket 102, and the mounting bracket 102 is attached to an interior surface of the end cap 14. The plurality of trays 104 are pivotally moveable between stacked and unstacked positions to provide access to the contents of each tray. In FIG. 1, the plurality of trays 104 are shown in a stacked position.

The protective housing 12 is sealed to the end cap 14 after splicing operations on the fiber optic cables are completed, and the splices are stored on the trays 104. The protective housing 12 protects the splice organizer 100 from outside elements such as water, moisture, dirt, and the like. The enclosure 10 can be fixed to a pole line such that the enclosure 10 can be installed aerially, or the enclosure 10 can be installed underground in a manhole or directly buried in the ground, as well as in other suitable locations.

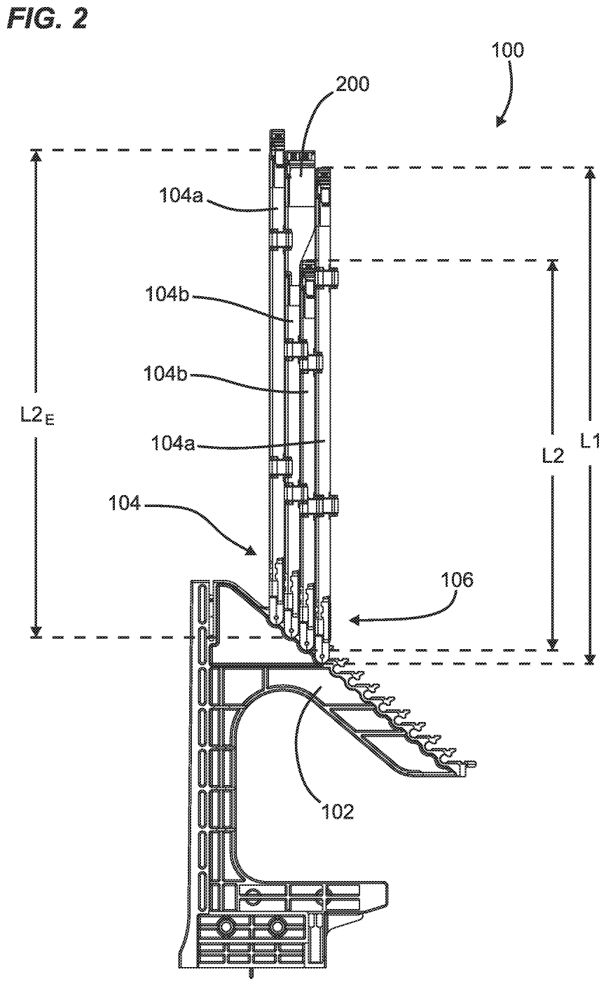

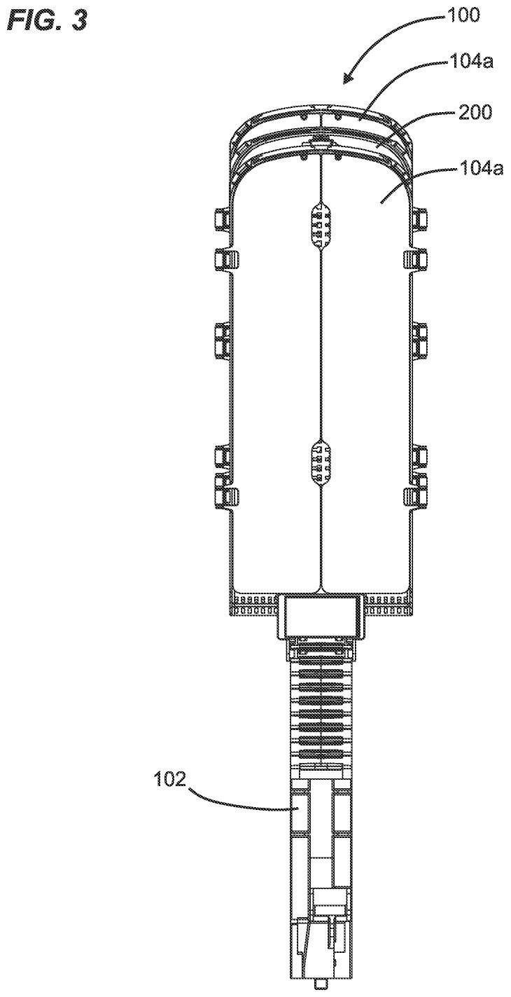

FIGS. 2 and 3 are side and front views of the splice organizer 100, respectively. As shown in FIGS. 2 and 3, the splice organizer 100 includes at least one tray of a first type 104a and at least one tray of a second type 104b. In the example embodiment shown in the figures, two trays of the second type 104b are sandwiched between two trays of the first type 104a.

The tray of the first type 104a has a length L1, and the tray of the second type 104b has a length L2. In this example, the length L1 is longer than the length L2. Thus, the trays of the first and second type 104a, 104b have different lengths. In some examples, the length L1 can range from about 420 mm to about 170 mm. In certain examples, the length L1 can range from about 330 mm to about 230 mm. In some examples, the length L2 can range from about 330 mm to about 170 mm. Additional lengths for the trays of the first and second type 104a, 104b are possible, and the lengths specified herein are provided for illustrative purposes only.

Due to the longer length L1 of the tray of the first type 104a than the length L2 of the tray of the second type 104b, the tray of the first type 104a has a capacity for storing a larger quantity of fiber optic splices than the tray of the second type 104b. In certain examples, the first type 104a has a capacity for storing about 576 to about 24 fiber optic splices, and the tray of the second type 104b has a capacity for storing about 96 to about 24 fiber optic splices. Additional storage capacities for the trays of the first and second type 104a, 104b are possible, and the storage capacities specified herein are provided for illustrative purposes only.

While the splice organizer 100 is described herein as having at least one tray of a first type 104a and at least one tray of a second type 104b, it is contemplated that the splice organizer 100 may include a plurality of each of the first and second type 104a, 104b of trays. For example, the splice organizer 100 shown in FIGS. 1-3 includes first and second trays of the first type 104a, and first and second trays of the second type 104b.

The splice organizer 100 can include additional types of trays of different lengths in addition, or alternatively to the trays of the first and second type 104a, 104b shown in FIGS. 1-3. For example, the splice organizer 100 can further include at least one tray of a third type pivotally attached to the mounting bracket 102 that has a length L3 for storing a third amount of fiber optic splices, the splice organizer 100 can further include at least one tray of a fourth type pivotally attached to the mounting bracket 102 that has a length L4 for storing a fourth amount of fiber optic splices, and can further include at least one tray of a fifth type pivotally attached to the mounting bracket 102 that has a length L5 for storing a fifth amount of fiber optic splices.

In certain examples, the length L3 of the trays of the third type can range from about 420 mm to about 320 mm. In certain examples, the length L4 of the trays of the fourth type can range from about 330 mm to about 230 mm. In certain examples, the length L5 of the trays of the fifth type can range from 240 mm to about 170 mm.

Still referring to FIGS. 1-3, a modular extension 200 is attached to one of the trays of the second type 104b. The modular extension 200 increases the length L2 of the tray of the second type 104b to an extended length L2_{E} to increase the capacity of the tray to store additional fiber optic splices, devices, tools, equipment, and the like. The modular extension 200 provides a storage area for fiber optic equipment. In certain examples, the storage area provided by the modular extension 200 can be used to store one or more patch cord connectors.

When the modular extension 200 is attached to the tray of the second type 104b, the extended length L2_{E} can be shorter than, equal to, or longer than the length L1 of the tray of the first type 104a. In certain examples, the length L2_{E} is about the same as the length L1. In certain examples, the length L2_{E} can range from about 420 mm to about 170 mm.

While the modular extension 200 is shown attached to the tray of the second type 104b, the modular extension 200 can also be attached to one or more of the trays of the first type 104a to extend the length and capacity of these trays. Additionally, the modular extension 200 can be attached to the trays of the third, fourth, or fifth type to increase the length and capacity of these trays. The modular extension 200 will be described in more detail below.

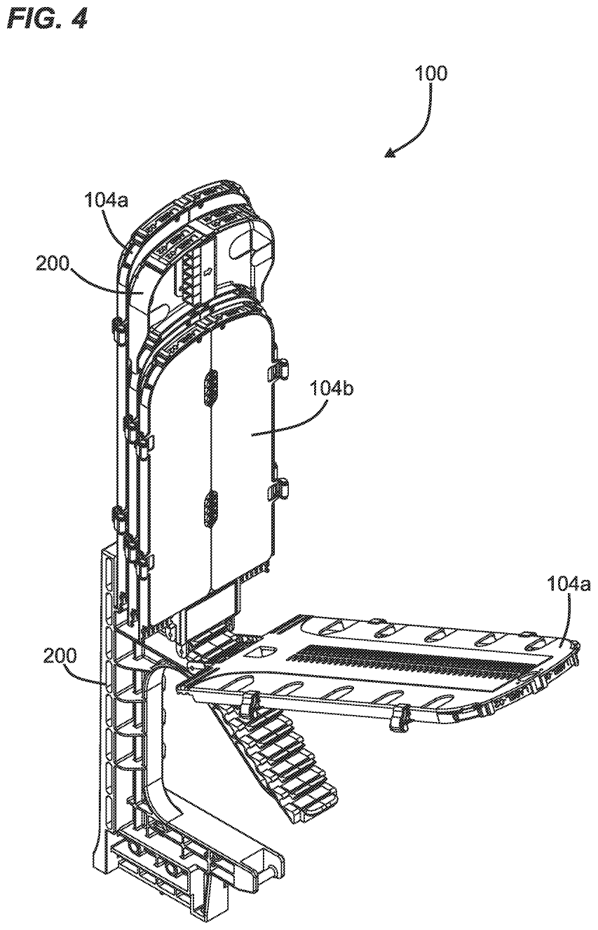

FIG. 4 is an isometric view of the splice organizer 100 showing a first tray of the first type 104a pivoted in an unstacked position 108, and exposing a first tray of the second type 104b nested within a space defined by another tray of the second type 104b and the modular extension 200. Referring now to FIGS. 1-4, the first tray of the first type 104a and the first tray of the second type 104b are attached to the mounting bracket 102 such that the first tray of the first type 104a at least partially overlaps the first tray of the second type 104b when both trays are in the stacked position 106, and the first tray of the first type 104a is pivotally moveable from the stacked position 106 to the unstacked position 108 such that the first tray of the first type 104a no longer overlaps the first tray of the second type 104b to provide access to the fiber optical splices and other fiber optic equipment held on the first tray of the second type 104b.

Alternatively, the first tray of the first type 104a and the first tray of the second type 104b can be attached to the mounting bracket 102 such that the first tray of the second type 104b at least partially overlaps the first tray of the first type 104a, and the first tray of the second type 104b is pivotally moveable from the stacked position 106 to the unstacked position 108 to provide access to the fiber optical splices on the first tray of the first type 104a.

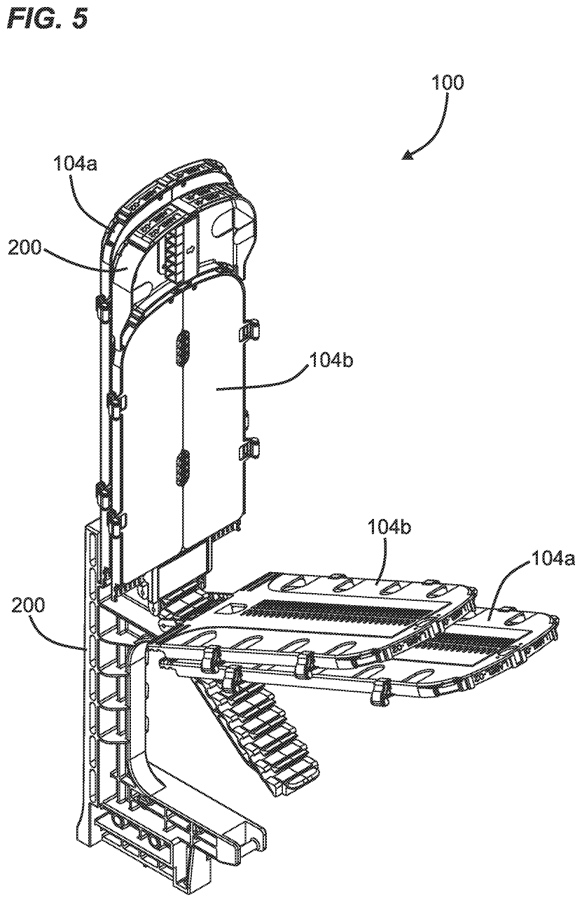

FIG. 5 is an isometric view of the splice organizer 100 showing the first tray of the first type 104a and the first tray of the second type 104b in the unstacked position 108, and exposing a second tray of the second type 104b attached to a modular extension 200 in the stacked position 106. As shown in FIGS. 1-5, the first trays of the first and second type 104a, 104b are both pivotally moveable from the stacked position 106 to the unstacked position 108 to provide access to the fiber optical splices on the second tray of the second type 104b, and the fiber optic equipment stored on the modular extension 200 such as patch cord connectors.

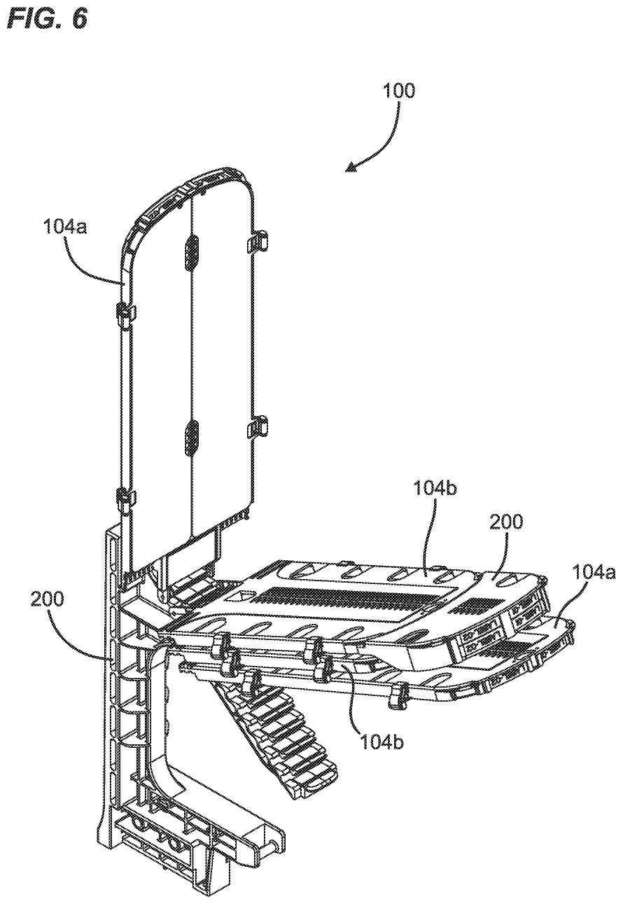

FIG. 6 is an isometric view of the splice organizer 100 showing the first tray of the first type 104a and the first and second trays of the second type 104b in the unstacked position 108, and exposing a second tray of the first type 104a in the stacked position 106. As shown in FIGS. 1-6, the first tray of the first type 104a and the first and second trays of the second type 104b are pivotally moveable from the stacked position 106 to the unstacked position 108 to provide access to the fiber optical splices on the second tray of the first type 104a.

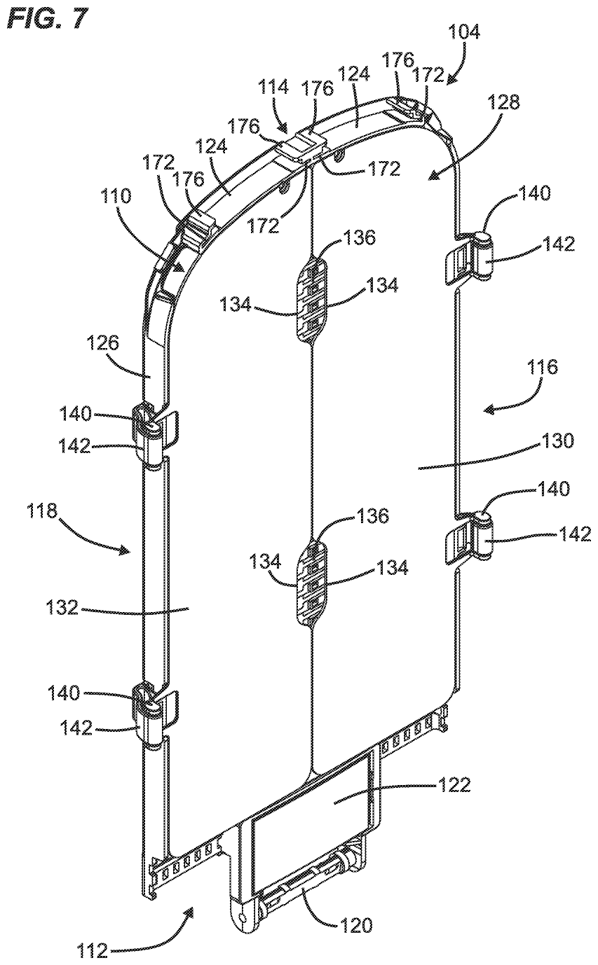

FIGS. 7-9 are isometric, top, and proximal end views of an example embodiment of a tray 104. The following description of the tray 104 is applicable to the trays of the first and second type 104a, 104b described above, as well as trays having additional sizes such as the trays of the third, fourth, and fifth types that are described above.

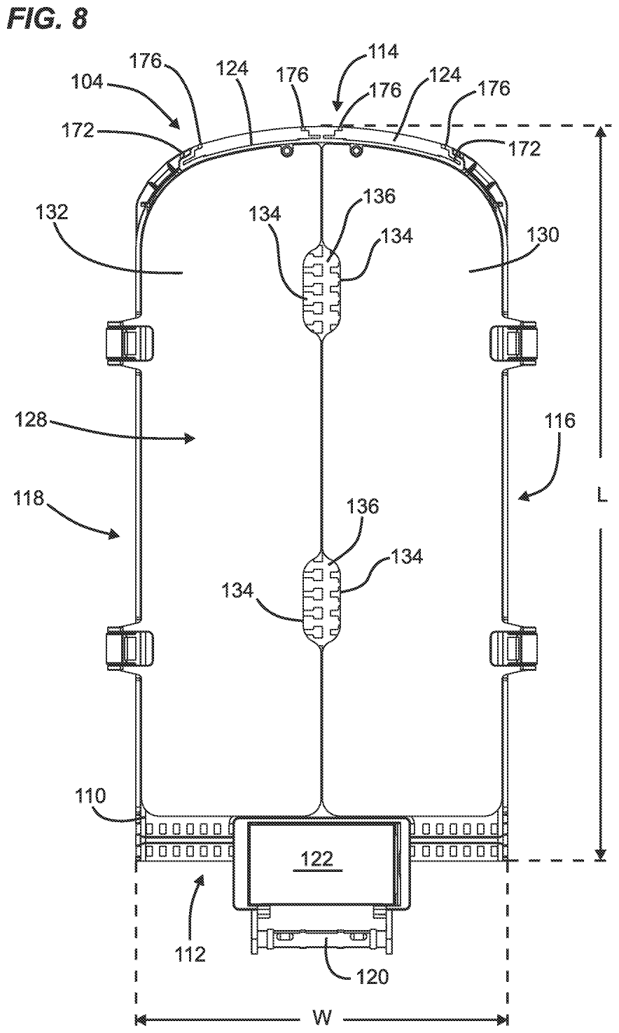

Referring now to FIGS. 7-9, the tray 104 has a base 110 that extends from a proximal end 112 to a distal end 114, and that has first and second lateral sides 116, 118. As shown in FIG. 8, the base 110 has a length L that is defined by a distance between the proximal end 112 and the distal end 114, and a width W that is defined by a distance between the first and second lateral sides 116, 118. In the example shown in the figures, the base 110 has a substantially rectangular shape. In certain examples, the length L of the base 110 can range from about 370 mm to about 120 mm. In certain examples, the width W of the base 110 can range from about 150 mm to about 110 mm. Additional dimensions for the length L and width W of the base 110 are possible, and the dimensions specified herein are provided for illustrative purposes only.

A hinge 120 is attached to the proximal end 112 of the base 110. The hinge 120 is used to pivotally attach the tray 104 to the mounting bracket 102.

As shown in FIGS. 7 and 8, a label area 122 is provided on the hinge 120 where the tray 104 attaches to the mounting bracket 102. The label area 122 is configured to secure a label to the tray 104 to identify the contents of the tray 104.

As shown in FIGS. 7-9, the tray 104 further includes at least one label area 124 at the distal end 114 of the base 110. The label area 124 is defined by a front portion of a sidewall 126 at the distal end 114 of the tray 104. The label area 124 is configured to hold a label for identifying the tray 104 and the contents thereon. Additionally, the label area 124 is structured to provide a space for connecting the modular extension 200 to the tray 104.

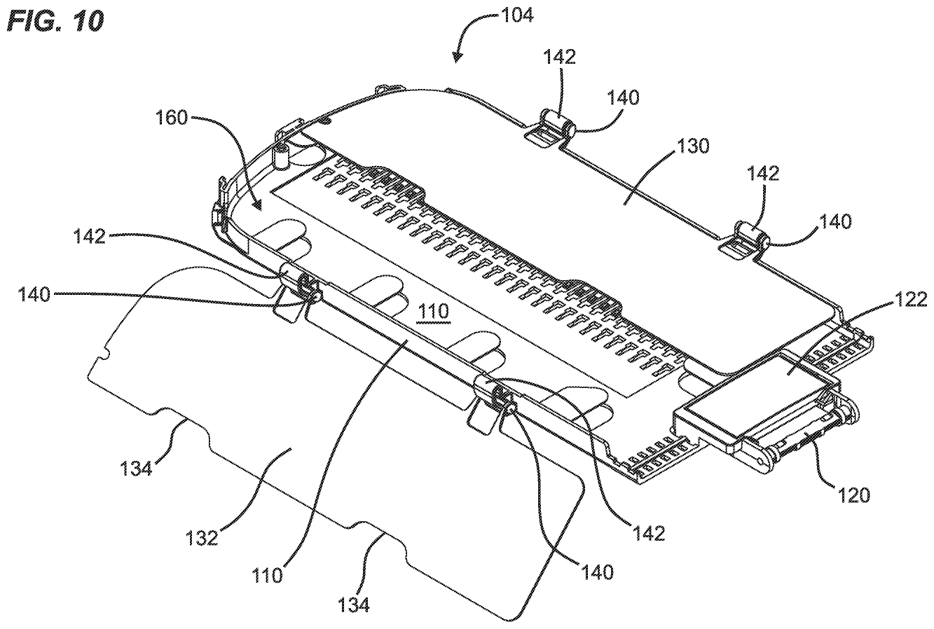

Still referring to FIGS. 7-9, the tray 104 incudes a cover 128 that encloses an interior volume 160 of the tray defined by the base 110 and the sidewall 126. In the embodiment depicted in the figures, the cover 128 includes a first panel 130 attached to the first lateral side 116 of the tray 104 and a second panel 132 attached to the second lateral side 118 of the tray 104. As shown in FIGS. 7 and 8, the first and second panels 130, 132 can each include one or more grooves 134 that allow a technician to grasp the first and second panels 130, 132. For example, when the first and second panels 130, 132 are in a closed position, as shown in FIGS. 7 and 8, the grooves 134 each partially define an aperture 136 in which the technician can place a hand or fingers therein to grasp the first and second panels 130, 132, and to rotate them from the closed position shown in FIGS. 7 and 8 to a stowed position, as shown in FIGS. 10-13.

The first and second panels 130, 132 each include one or more attachment members 140 that rotate and slide inside attachment members 142 on the first and second lateral sides 116, 118 of the tray 104. The attachment members 140, 142 allow the first and second panels 130, 132 to rotate and slide from facing a top surface 150 of the tray 104 to facing a bottom surface 152 of the tray 104. In FIGS. 7-9, the first and second panels 130, 132 block access to the interior volume 160 when the first and second panels 130, 132 are in the closed position.

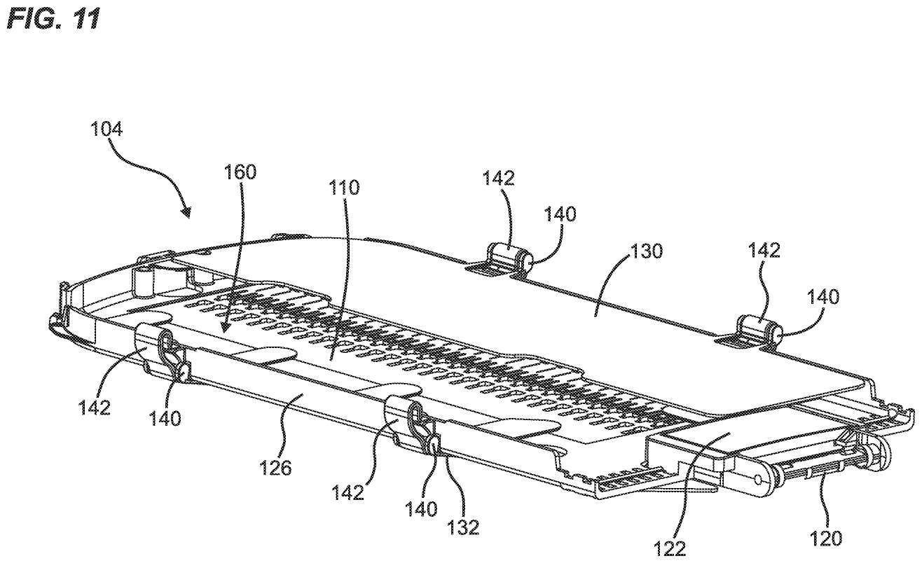

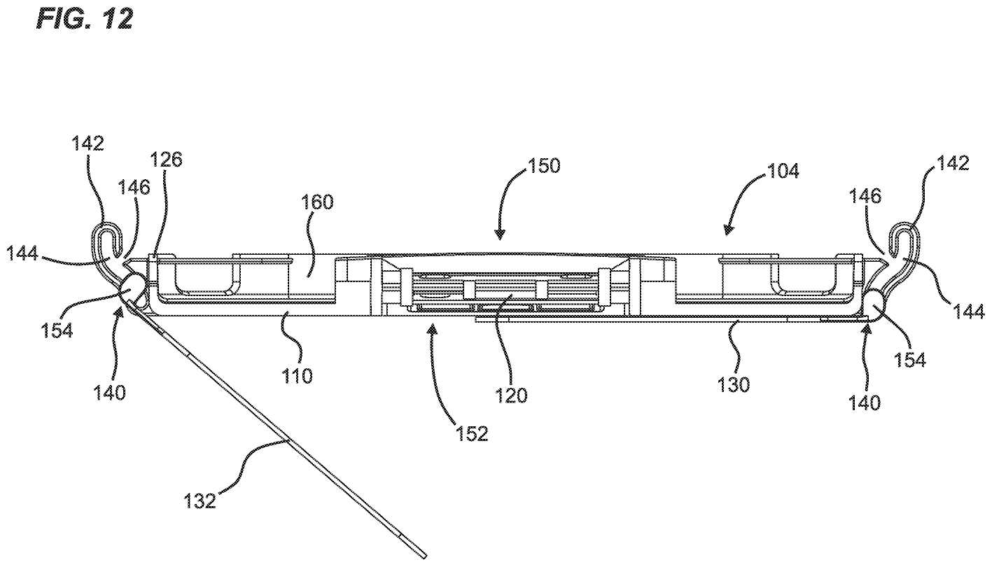

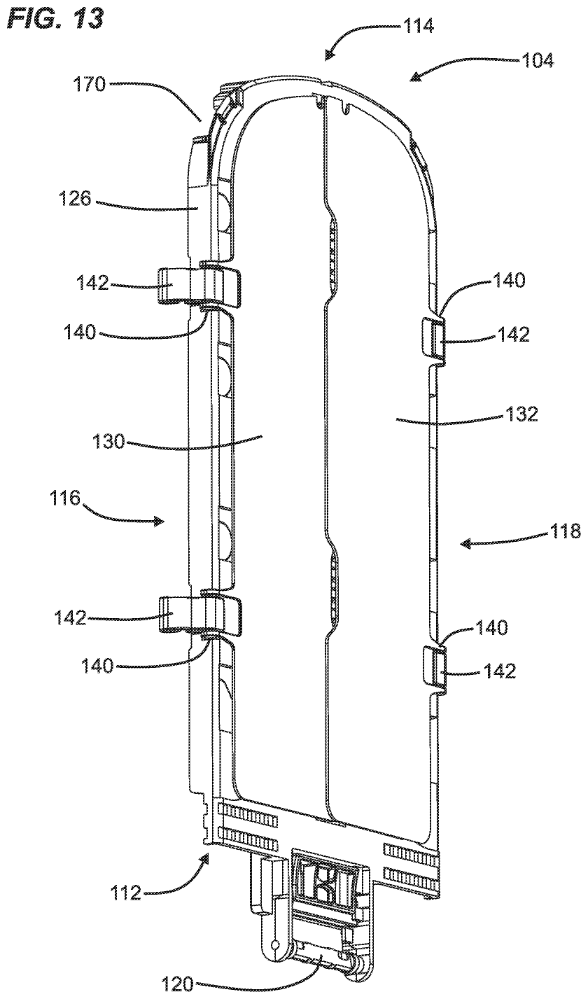

FIG. 10 is an isometric view of the tray 104 showing the second panel 132 partially rotated from the closed position to a stowed position. FIG. 11 is an isometric view of the tray 104 showing the second panel 132 in the stowed position such that the second panel 132 faces the bottom surface 152 of the tray 104. FIG. 12 is a proximal end view of the tray 104 showing the first panel 130 in the stowed position, and the second panel 132 partially rotated from the closed position to the stowed position. FIG. 13 is an isometric, bottom view of the tray 104 with both the first and second panels 130, 132 in the stowed position. The first and second panels 130, 132 allow access to the interior volume of the tray 104 when in the stowed position.

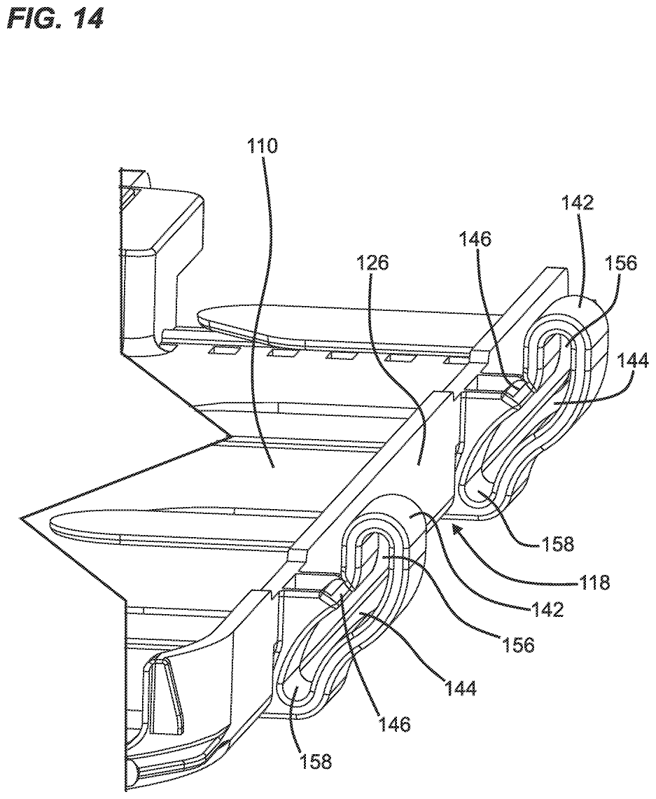

FIG. 14 is a detailed view of the attachment members 142 provided on the second lateral side 118 of the tray 104. Referring now to FIGS. 7-14, the attachment members 140 on the first and second panels 130, 132 are configured to rotate and slide inside channels 144 defined by the attachment members 142 to change the position and orientation of the first and second panels 130, 132 from the closed position to the stowed position. The attachment members 142 on the first and second lateral sides 116, 118 of the tray 104 prevent the first and second panels 130, 132 from becoming detached from the tray 104 when in the stowed position. This advantageous because when the enclosure 10 is installed in the field such as when it is fixed to a pole line, the first and second panels 130, 132 will not fall to the ground, making it easier for a technician to work on the tray 104 without having to worry about re-attaching the panels.

The attachment members 142 on the first and second lateral sides 116, 118 each include a slot 146 that allows the attachment members 140 on the first and second panels 130, 132 to be disengaged from the channel 144, and to thereby allow the first and second panels 130, 132 to be removed from the tray 104 without requiring the use of any tools.

Still referring to FIG. 14, each channel 144 includes a first end 156 and a second end 158 that have shapes that correspond to the attachment members 140 on the first and second panels 130, 132. The shape of the first and second ends 156, 158 allows the first and second panels 130, 132 to lock in the closed and stowed positions. For example, as shown in FIG. 12, the shape of the second end 158 corresponds to a lobe 154 of the attachment member 140 of the first panel 130 that allows the first panel 130 to be locked in the stowed position and remain parallel to the bottom surface 152. This is advantageous because by locking the first and second panels 130, 132 to remain parallel to the bottom surface 152, the first and second panels 130, 132 will not dangle downwardly due to gravity, and instead, will be held against the bottom surface 152 to avoid interference with the other trays pivotally attached to the mounting bracket 102.

In the embodiment depicted in the figures, the attachment members 142 on the tray 104 define the channels 144 in which the attachment members 140 on the first and second panels 130, 132 rotate and slide. In alternative embodiments, the attachment members 140 on the first and second panels 130, 132 can define the channels 144, and the attachment members 142 on the tray 104 rotate and slide within the channels 144 defined by the attachment members 140.

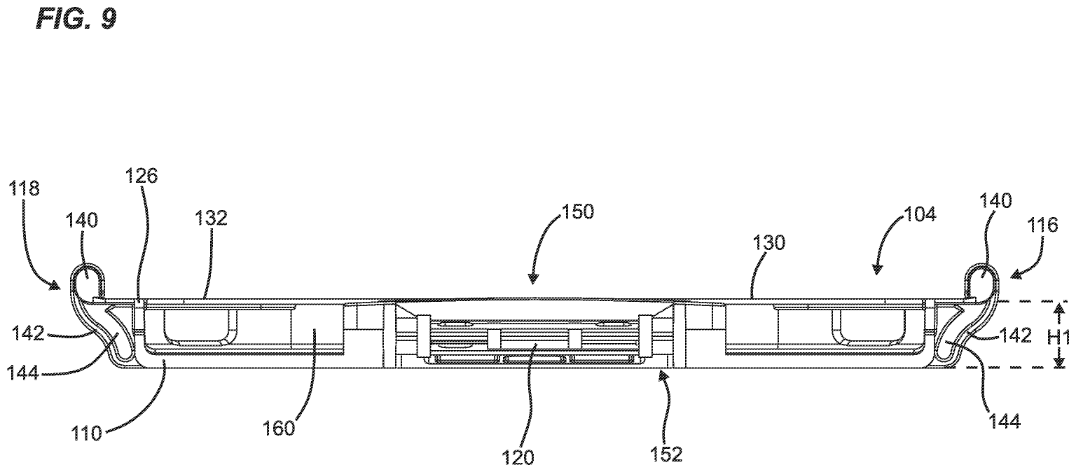

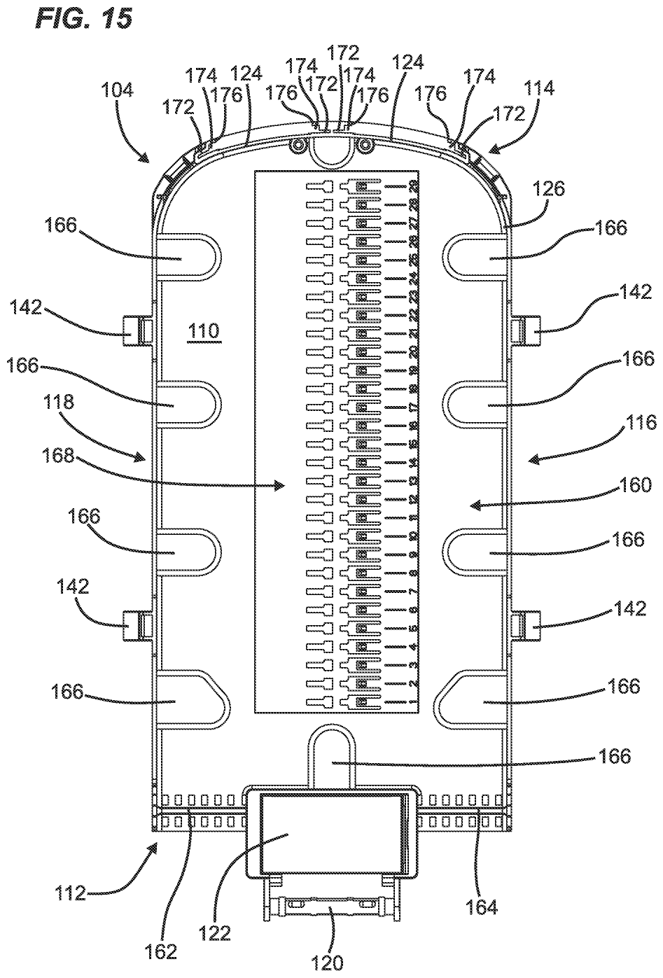

FIG. 15 is a top view of the tray 104 with both the first and second panels 130, 132 in the stowed position. Referring now to FIG. 15, the sidewall 126 surrounds at least the distal end 114 and first and second lateral sides 116, 118 of the base 110. As shown in FIG. 9, the sidewall 126 of the tray 104 has a height H1. As described above, the base 110 and the sidewall 126 define an interior volume 160 of the tray 104 that is configured to store fiber optic splices and fiber optic cable slack, as well as other fiber optic devices, tools, equipment, and the like.

The proximal end 112 of the base 110 includes openings 162, 164 on opposite sides of the hinge 120 where the base 110 pivotally attaches to the mounting bracket 102. Also, the label area 122 is located on the hinge 120 at the proximal end 112. As described above, the label area 122 is configured to secure a label to the tray to identify the contents of the tray 104.

Fiber optic cables enter the interior volume 160 through the openings 162, 164 at the proximal end 112 of the tray 104. Cable managers 166 extend from the sidewall 126 across a portion of the base 110. The cable managers 166 can aid in retaining slack portions of the fiber optic cables within the interior volume 160 defined by the sidewall 126 and base 110 of the tray 104. In some examples, the cable managers are guide tabs.

The base 110 further includes a plurality of splice holder 168. In the embodiment depicted in the figures, the plurality of splice holders 168 are arranged in a linear row that extends from the proximal end 112 to the distal end 114 of the base 110. Alternative arrangements for organizing the plurality of splice holders 168 on the base 110 are possible.

In some example embodiments, the interior volume 160 of the tray 104 has a capacity for about 36-40 splice holders 168. In some example embodiments, the interior volume 160 of the tray 104 has a capacity for storing about 26-32 splice holders 168.

During operation, optical fibers from the fiber optic cables that enter the interior volume 160 are spliced together. Thereafter, the splices are held and supported by the splice holders 168 on the base 110. The splice holders 168 can secure several splices in side-by-side relation. Advantageously, the splice holders 168 securely hold the splices and prevent damage to the splices that can be caused by mechanical shock and vibration. The splice holders 168 can accommodate a variety of different splice sizes and shapes with different external dimensions. Many different splice holders could be used as suggested by those skilled in the art.

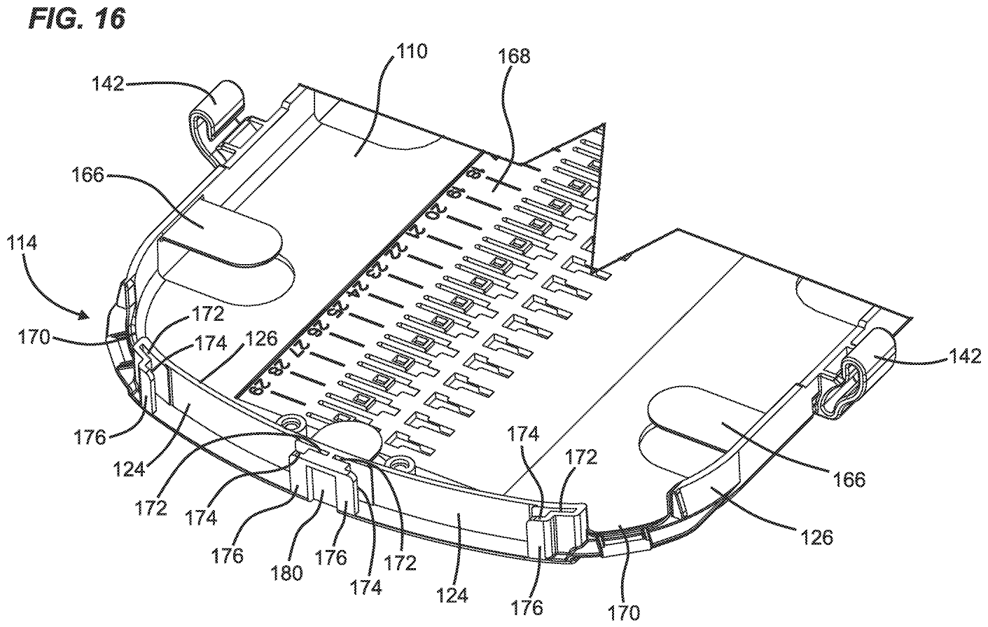

FIG. 16 is an isometric view of the distal end 114 of the tray 104. Referring now to FIGS. 15 and 16, the sidewall 126 at the distal end 114 of the tray 104 includes one or more label areas 124 for securing one or more labels to the distal end 114 of the tray 104. Each label area 124 is a pocket defined in the sidewall 126 that includes slots 172 on opposite sides thereof.

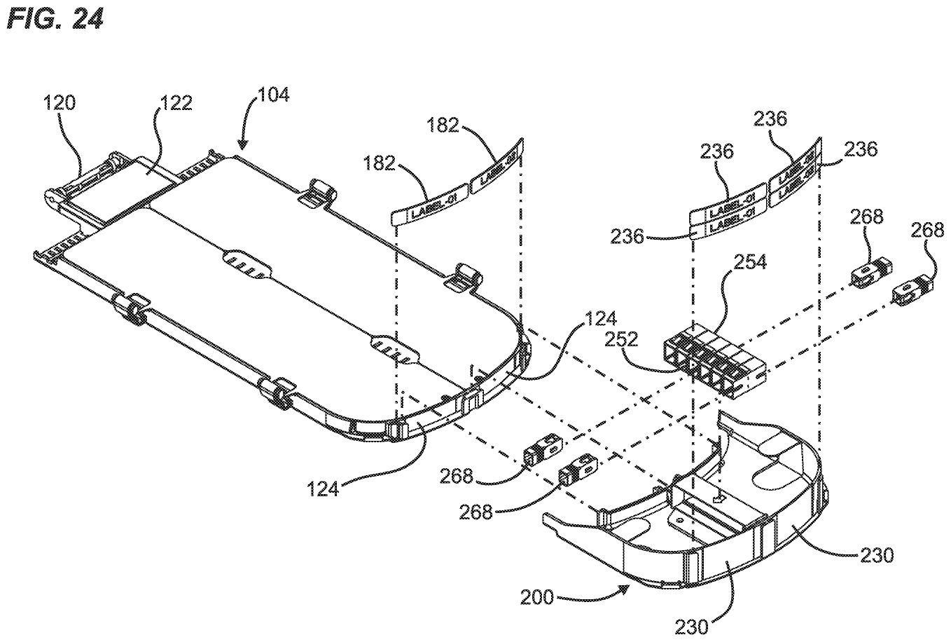

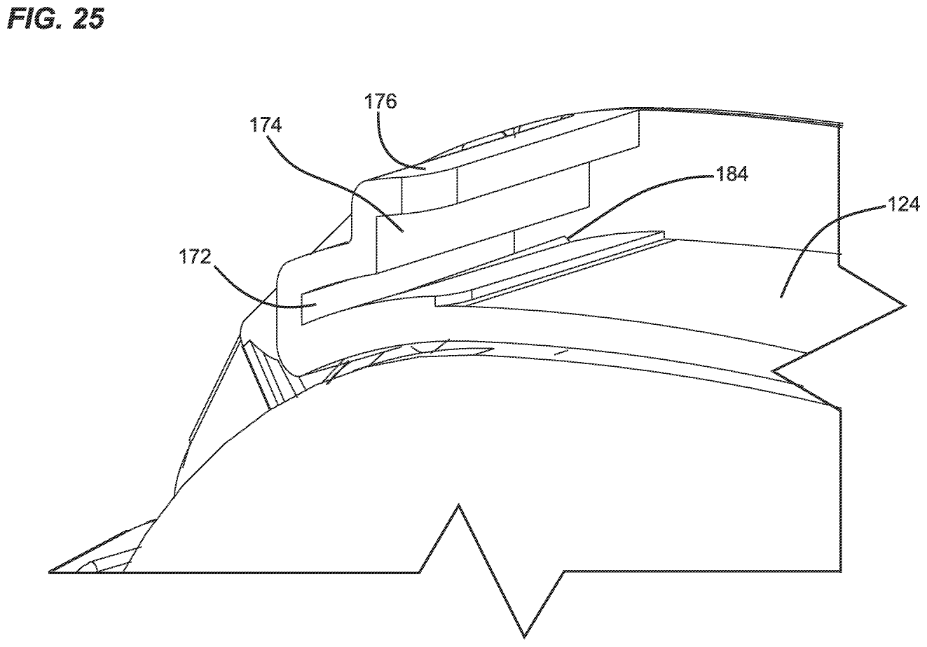

FIG. 24 is an exploded view of the tray 104 showing the insertion of the labels 182 into the label areas 124 of the tray 104. FIG. 25 is a detailed view of a slot 172 of a label area 124 of the tray 104. Referring now to FIGS. 15, 16, 24, and 25, each slot 172 can include a retention member 184 that retains the ends of a label 182 inside a label area 124 by friction. Advantageously, this can prevent the label 182 from accidentally sliding out of the label area 124 when the tray 104 is pivoted into the unstacked position, such as shown in FIG. 4. In the example shown in FIG. 25, each retention member 184 can have a sloped surface that gradually increases toward an interior of the label area 124 such that when a label 182 is inserted into the label area 124, the ends of the label are retained inside the label area 124 by friction. When desired, the label 182 can be removed from the label area 124 by pulling the label out of the label area 124.

In the embodiment depicted in the figures, the sidewall 126 includes two separate label areas 124 for securing two labels to the tray 104. The labels secured to the tray 104 by the slots 172 can be used to identify the tray 104 and the contents stored thereon.

As further shown in FIG. 16, the distal end 114 of the tray 104 includes slots 174 that are each defined by a tab 176 on the sidewall 126. The slots 174 are positioned in front of the label areas 124. The distal end 114 of the tray 104 further includes a receptacle 180 on the sidewall 126. As will be described in more detail, the slots 174 and the receptacle 180 allow the proximal end 204 of the modular extension 200 to be removably attached to the distal end 114 of the modular extension 200 to extend the length and storage capacity of the tray 104.

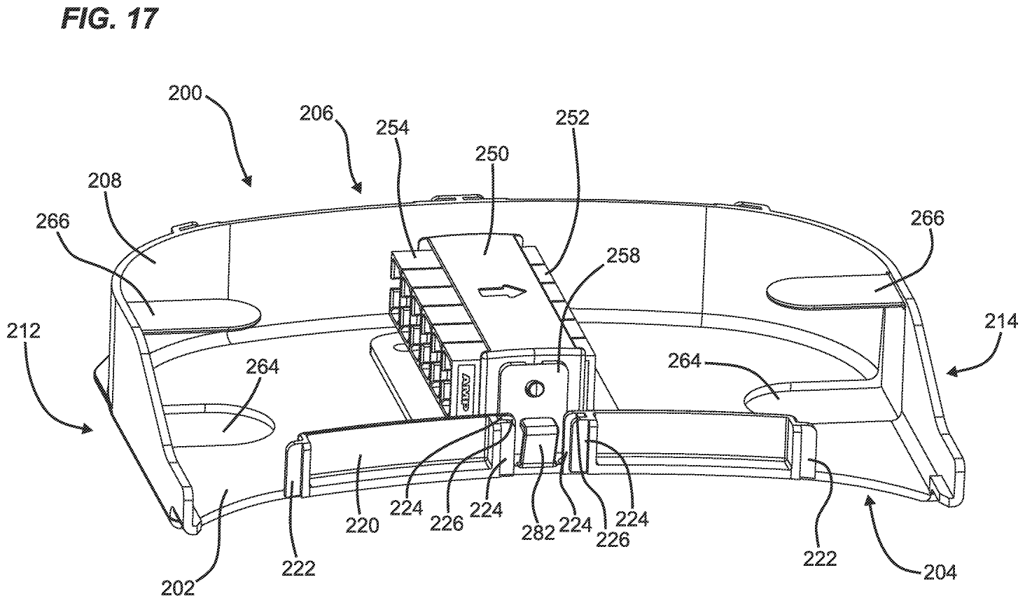

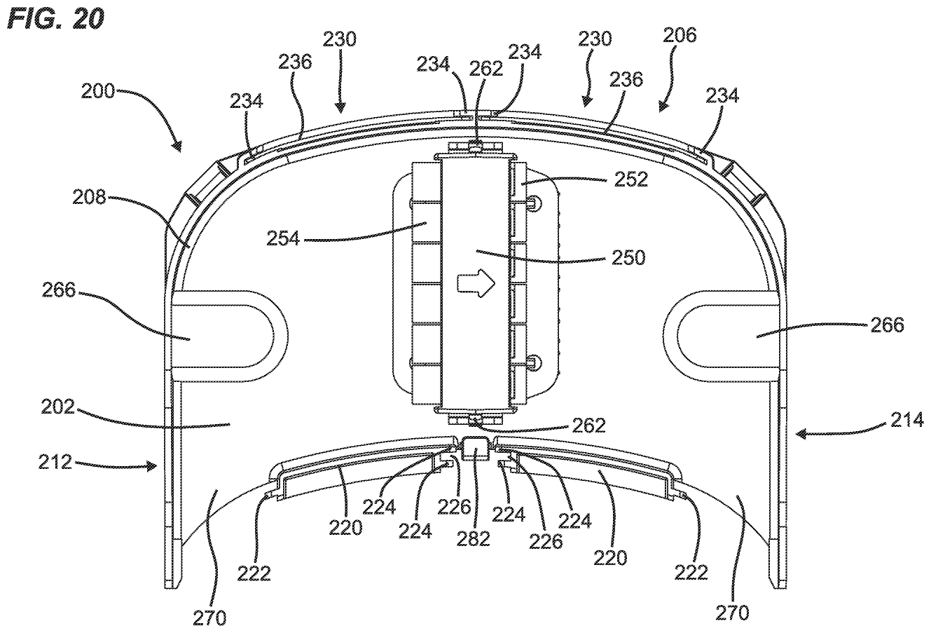

FIG. 17 is an isometric view of the modular extension 200. FIG. 20 is a top view of the modular extension 200. Referring now to FIGS. 17 and 20, the modular extension 200 includes a base 202 that extends between a proximal end 204 and a distal end 206, and between opposite lateral sides 212, 214. The modular extension 200 further includes a sidewall 208 that surrounds at least the distal end 206 and the lateral sides 212, 214 of the base 202.

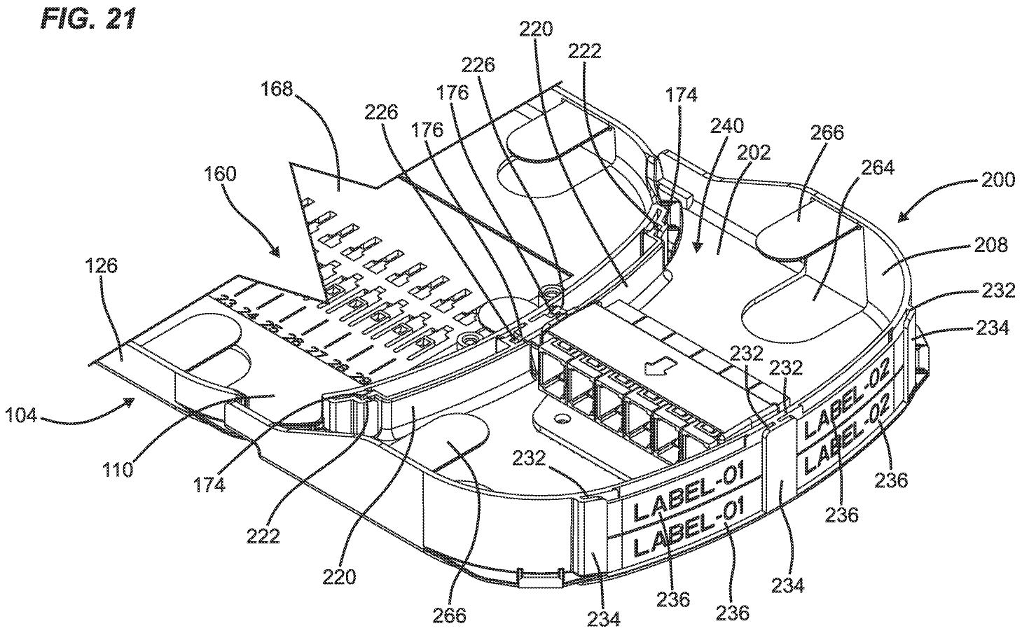

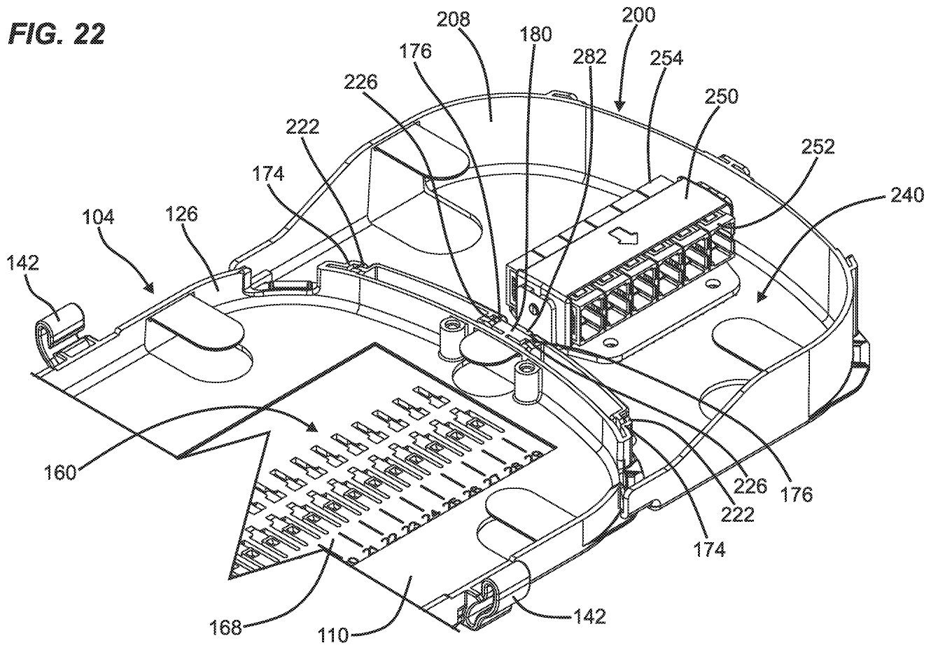

FIGS. 21 and 22 are isometric views of the tray 104 with the modular extension 200 attached thereto. Referring now to FIGS. 16, 17, 21, and 22, the modular extension 200 includes one or more projections 220 that extend orthogonally from the base 202 at the proximal end 204. The projections 220 each include tabs 222 that slide into the slots 174 at the distal end 114 of the tray 104. The projections 220 further include tabs 224 that define slots 226 that receive the tabs 176 on the sidewall 126. In the embodiment depicted in the figures, the tabs 222, 224 are positioned on opposite sides of each projection 220. Alternative arrangements are possible such as where the modular extension 200 includes a single projection 220 instead of a pair of projections 220. Also, the one or more projections may include only the tabs 222, or alternatively, may include only the tabs 224, or may include any combination thereof.

The modular extension 200 further includes a tab 282 that snap fits into the receptacle 180 on the tray 104. Accordingly, the modular extension 200 is removably attachable to the distal end 114 of the tray 104 to extend the length and storage capacity of the tray.

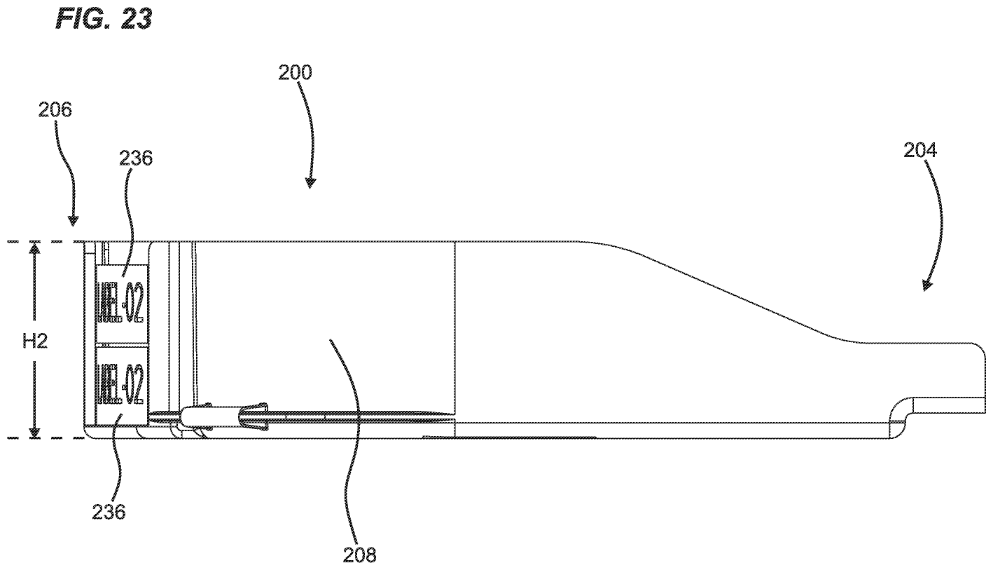

FIG. 23 is a side view of the modular extension 200. Referring now to FIG. 23, the sidewall 208 of the modular extension 200 has a height H2. The height H2 of the modular extension 200 is larger than the height H1 of the tray 104 (see FIG. 9). In certain examples, the height H2 of the modular extension 200 is about twice as tall as the height H1 of the tray 104. In certain examples, the height H1 can range from about 10 mm to about 15 mm, and the height H2 can range from about 20 mm to about 30 mm.

The larger height of the sidewall 208 of the modular extension 200 allows the modular extension to provide storage for fiber optic equipment that would ordinarily not fit in the interior volume 160 of the tray 104. For example, the modular extension 200 can be used to store patch cord connectors, as will be described in more detail below.

Additionally, the larger height of the sidewall 208 of the modular extension 200 provides a space in the splice organizer 100 where another tray 104 can be nested, and thereby provides a more efficient use of the space inside the enclosure 10. For example, FIG. 4 illustrates an example where a first tray of the second type 104b is nested within a space defined by another tray of the second type 104b and the modular extension 200.

Referring now to FIGS. 20, 21, and 24, the modular extension 200 includes one or more label areas 230 for securing one or more labels 236 to the modular extension 200. The label areas 230 are similar to the label areas 124 of the tray 104. The label areas 230 are defined by the sidewall 208 at the distal end 206 of the modular extension 200, and the label areas 230 are pockets for holding the labels 236 that can be used to identify the modular extension 200 and the contents stored thereon, as well as the tray 104 to which it is attached.

The label areas 230 include at least one slot 232 that is defined by one or more tabs 234 on the sidewall 208 for securing the labels 236 to the modular extension 200. Each slot 232 can include one or more retention members that secure the labels 236 inside the label areas 230 by friction. The retention members in the slots 232 of the modular extension 200 can be similar to the retention members 184 inside the slots 172 of the tray 104, as shown in FIG. 25.

In the example depicted in the figures, the sidewall 208 includes two separate slots 232 for securing two columns of labels to the modular extension 200. Also, due to the larger height of the sidewall 208, the label area 230 may include two or more rows of stacked labels.

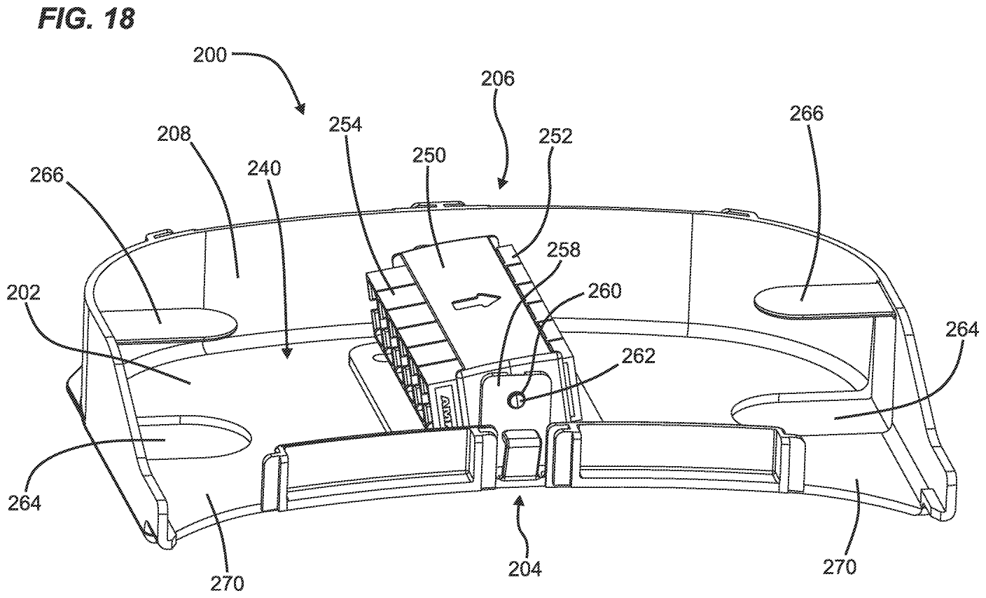

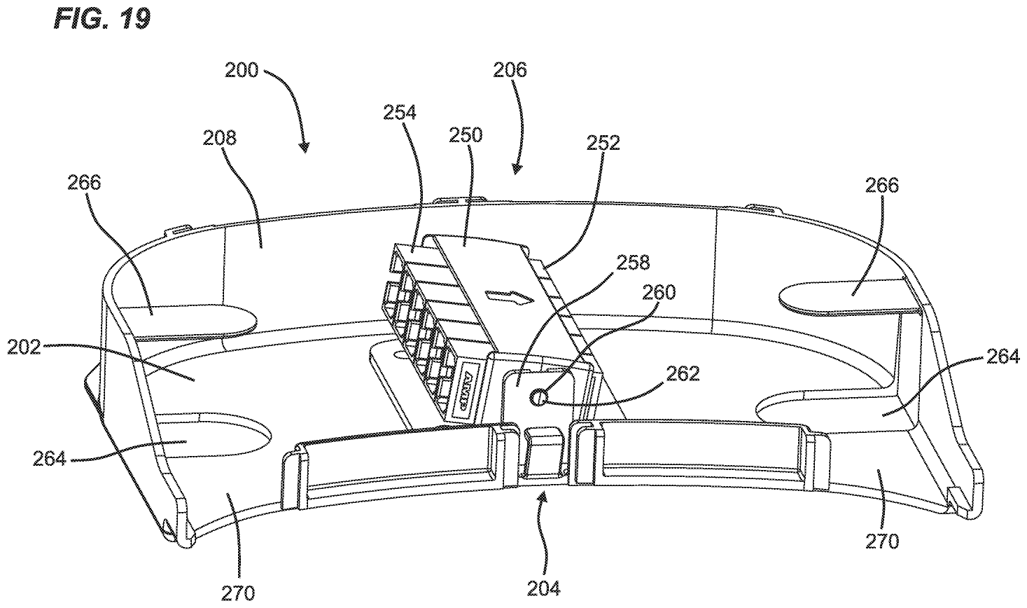

FIGS. 18 and 19 are isometric views of the proximal end 204 of the modular extension 200. Referring now to FIGS. 17-19, the base 202 and sidewall 208 together define a storage area 240 for storing fiber optic splices, devices, tools, equipment, and the like. In certain examples, the storage area 240 can be used to store a plurality of patch cord connectors.

The storage area 240 includes a platform 250 having first and second rows of adapters 252, 254. As shown in the exploded view of FIG. 24, connectors 268 can be inserted into the first and second rows of adapters 252, 254 for storing the connectors 268 in the storage area 240 of the modular extension 200. In certain examples, first and second rows of adapters 252, 254 are configured to store a plurality of patch cord connectors in the storage area 240.

The first row of adapters 252 are positioned on a first side of the platform 250, and the second row of adapters 254 are positioned on an opposite, second side of the platform 250. The platform 250 is pivotally connected to a bracket 258 that extends orthogonally from the base 202. In certain examples, the bracket 258 is attached to the base 202 by one or more fasteners such as screws. The bracket 258 includes apertures 260 on opposite sides, and the platform 250 includes pins 262 that extend axially. The pins 262 of the platform 250 are inserted into the apertures 260 of the bracket 258, and allow the platform 250 to rotate in clockwise and counterclockwise directions relative to the base 202 of the modular extension 200.

In FIG. 18, the platform 250 is partially rotated in the counterclockwise direction which causes the first row of adapters 252 to pivot upwards. This can help improve the accessibility of the first row of adapters 252 (and any type of connectors held therein) by allowing a technician to reach with their fingers underneath the first row of adapters 252.

In FIG. 19, the platform 250 is partially rotated in the clockwise direction which causes the second row of adapters 254 to pivot upwards. This can help improve the accessibility of the second row of adapters 254 (and any type of connectors held therein) by allowing a technician to reach with their fingers underneath the second row of adapters 254.

In addition to the platform 250 that is pivotally rotatable, the modular extension 200 further includes apertures 264 that extend through the base 202 for providing additional access to the first and second rows of adapters 252, 254. For example, a technician can place their fingers through the apertures 264 from the bottom of the modular extension 200 to reach underneath the first and second rows of adapters 252, 254 (and any type of connectors held therein).

Also, the modular extension 200 can include guide tabs 266 that extend from the sidewall 208 across a portion of the base 202. The guide tabs 266 can aid in retaining slack portions of the fiber optic cables such as patch cords within the modular extension 200.

Referring now to FIGS. 16, 21, and 22, the sidewall 126 at the distal end 114 of the tray 104 has one or more openings 170 that correspond with one or more openings 270 at the proximal end 204 of the modular extension 200 to provide access from the interior volume 160 of the tray 104 to the storage area 240 of the modular extension 200. The openings 170, 270 can allow fiber optic cables, such as patch cord cables, to extend through the interior volume 160 of the tray 104, and allow the connectors that terminate the cables to be stored in the adapters on the platform 250 inside the storage area 240 of the modular extension 200.

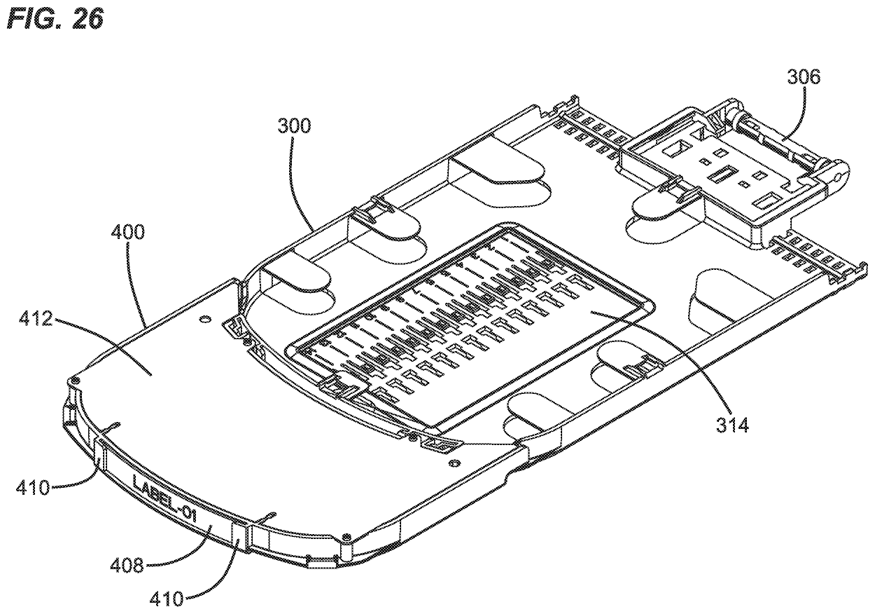

FIG. 26 is an isometric view of another example of a modular extension 400 attached to a tray 300. Like in the examples described above, the tray 300 can be pivotally attached to the mounting bracket 102 of the splice organizer 100 shown in FIG. 1. For example, the tray 300 includes a hinge 306 that can pivotally attach the tray 300 to the mounting bracket 102. Also, the tray 300 includes a splicing area 314 for securing a plurality of splice holders.

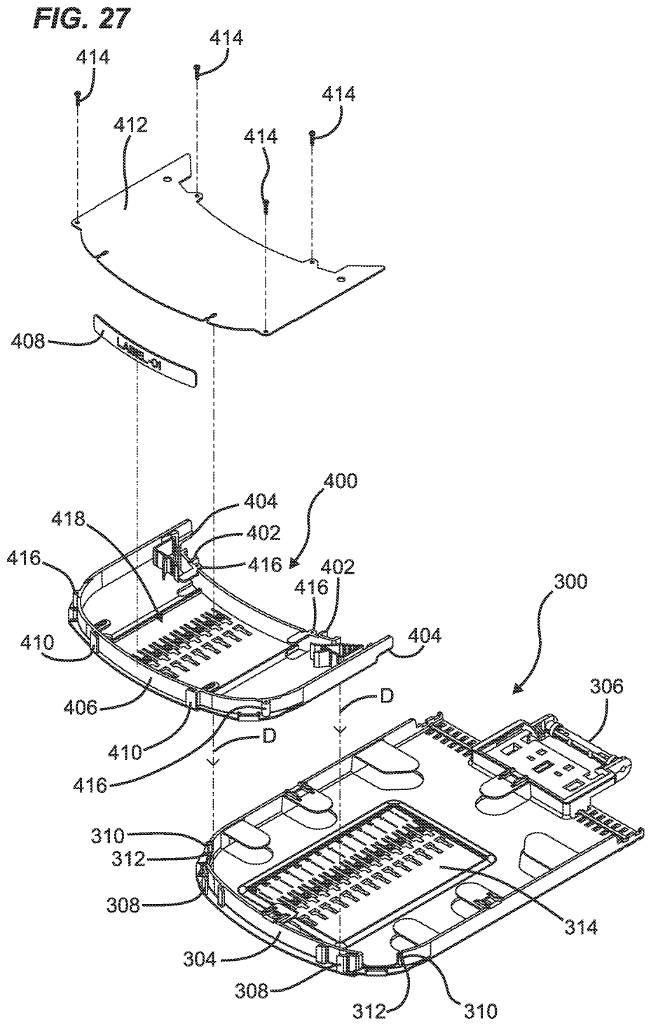

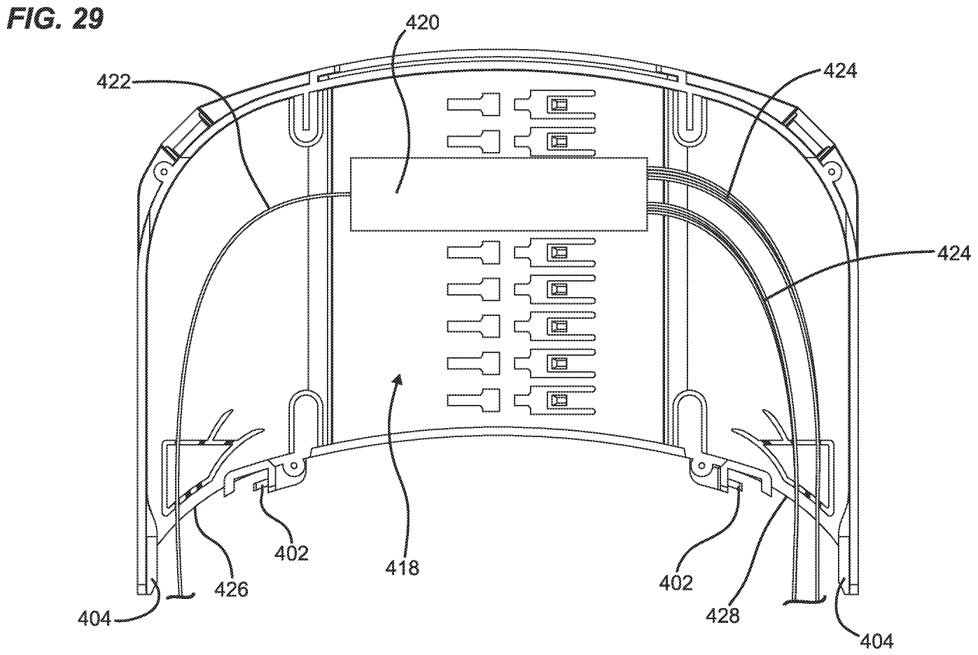

FIG. 27 is an exploded isometric view of the modular extension 400 and the tray 300. Referring now to FIGS. 26 and 27, the modular extension 400 attaches to a distal end 304 of the tray 300 in a similar fashion as the modular extension 200 and tray 104 described above. For example, the modular extension 400 includes tabs 402 (see FIG. 29) that engage tabs 308 located at the distal end 304 of the tray 300 to prevent the modular extension 400 from being pulled off the tray 300 in a direction orthogonal to the arrows D shown in FIG. 27.

Additionally, the modular extension 400 includes surfaces 404 (see FIG. 29) that are each configured to engage a corresponding ramped surface 310 on opposite sides of the distal end 304 of the tray 300 when the modular extension 400 is pushed down toward the tray 300 in the direction of the arrows D shown in FIG. 27. Each surface 404 slides along the corresponding ramped surface 310 until reaching a point past a shoulder 312 of each corresponding ramped surface 310, which prevents the modular extension 400 from being pulled off the tray 300 in a direction parallel to the arrows D shown in FIG. 27. In this example, the modular extension 400 snap-fits into the distal end 304 of the tray 300. In alternative examples, the modular extension 400 can attach to the distal end 304 of the tray 300 by using other attachment mechanisms such as by using one or more fasteners to secure the modular extension 400 to the tray 300.

The modular extension 400 includes at least one label area 406 at a distal end. The at least one label area 406 is configured to hold a label 408 for identifying the modular extension 400 and the tray 300, and the contents stored thereon. The at least one label area 406 can include tabs that define a pocket for holding the label 408 at a distal end of the modular extension 400.

The modular extension 400 incudes a cover 412 that encloses an interior volume 418. In the example shown in the figures, the cover 412 attaches around a perimeter of the modular extension 400 using one or more fasteners 414. The fasteners 414 are screws that screw into apertures 416 on the modular extension 400 to secure the cover 412 to the modular extension 400. Alternative types of fasteners may be used to secure the cover 412 to the modular extension 400 such as additional types of mechanical fasteners, and adhesives such as glue or epoxy.

In some examples, the cover 412 is permanently attached to the modular extension 400 to prevent end users from having access to the interior volume 418. In such examples, the cover 412 can be permanently glued to the modular extension 400.

Alternatively, the cover 412 can be non-permanently attached such that the cover 412 can be removed from the modular extension 400 to provide access to the interior volume 418 as may be needed by an end user. In such examples, the cover 412 can be attached to the modular extension 400 using one or more mechanical fasteners such as screws.

The interior volume 418 provides a storage area for storing fiber optic equipment such as fiber optic connectors, adapters, splitters, and wave division multiplexers. In some examples, the interior volume 418 includes one or more fiber optic splitters. In other examples, the interior volume 418 includes one or more wave division multiplexers. In further examples, the interior volume 418 includes at least one fiber optic splitter and at least one wave division multiplexer. Additional combinations of fiber optic equipment can be stored in the interior volume 418, and these combinations of equipment are provided by way of example.

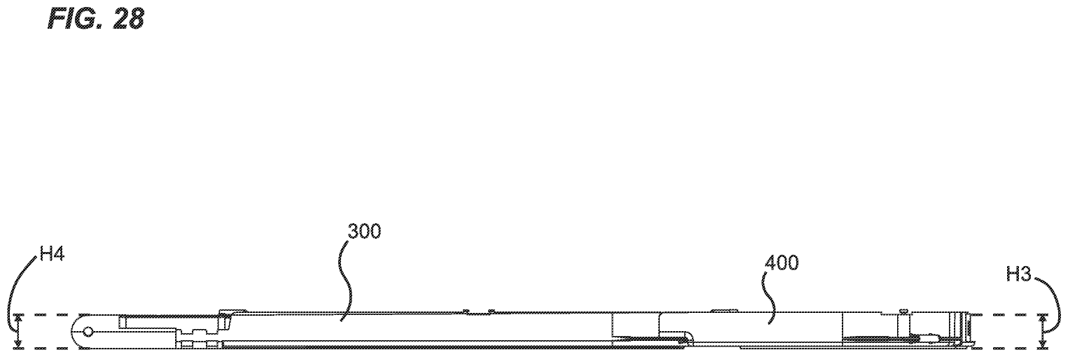

FIG. 28 is a side view of the modular extension 400 and the tray 300. As shown in FIG. 28, the modular extension 400 has a height H3 that is substantially similar or the same as a height H4 of the tray 300. Thus, top and bottom surfaces of the modular extension 400 are substantially flush and continuous with top and bottom surfaces of the tray 300.

FIG. 29 is a top view of the modular extension 400 with the cover 412 removed therefrom, exposing a fiber optic splitter 420 secured inside the interior volume 418 of the modular extension 400. At least one splitter input 422 enters the fiber optic splitter 420 from one side, and a plurality of splitter outputs 424 exit the fiber optic splitter 420 from an opposite side. As shown in FIG. 29, the at least one splitter input 422 enters the interior volume 418 through an opening 426 on one side of the modular extension, while the plurality of splitter outputs 424 exit the interior volume 418 through an opening 428 on an opposite side of the modular extension. In the example illustrated in the figures, the fiber optic splitter 420 is a 1×8 splitter such that the at least one splitter input 422 is split into 8 splitter outputs. Additional types of fiber optic splitters may be stored and secured inside the interior volume 418 as well as additional types of fiber optic equipment such as wave division multiplexers, connectors, adapters, and the like.

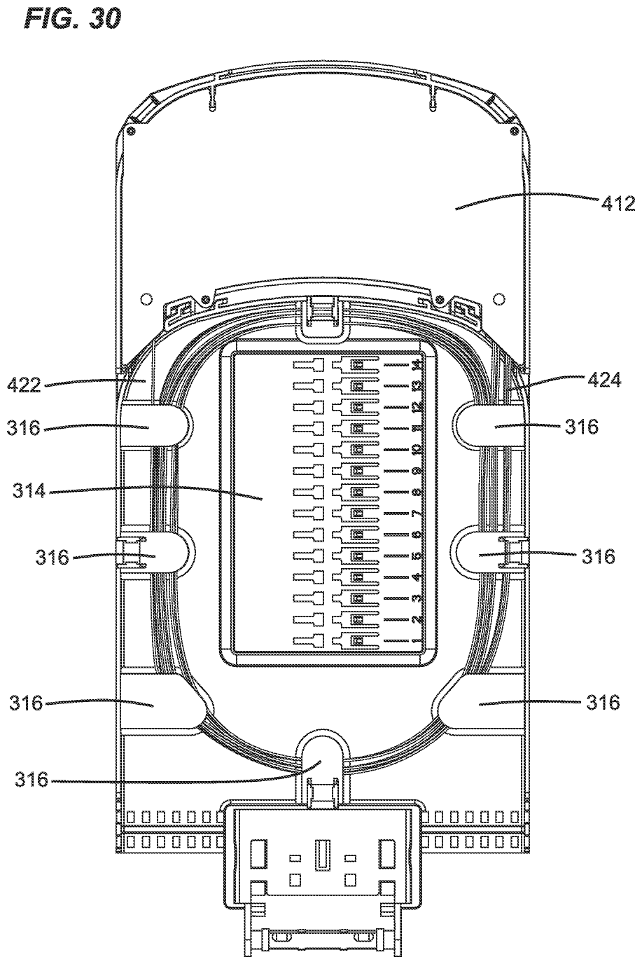

FIG. 30 is a top view of the tray 300 and modular extension 400 with the cover 412 attached thereto. As shown in FIG. 30, the splitter input 422 and splitter outputs 424 are organized by cable managers 316 on the tray 300. The cable managers 316 are similar to the cable managers 166 of the tray 104. The splitter input 422 and splitter outputs 424 can be spliced to one or more additional fiber optic cables in the splicing area 314. For example, one or more splice holders secured in the splicing area 314 can be used to splice the splitter input 422 and splitter outputs 424 to one or more additional fiber optic cables. As described above, the cover 412 can be permanently attached to the modular extension 400 to prevent end users from having access to the interior volume 418, or can be non-permanently attached.

The various embodiments described above are provided by way of illustration only and should not be construed to be limiting in any way. Various modifications can be made to the embodiments described above without departing from the scope of the disclosure.

What is claimed is:

1. A fiber optic splice organizer comprising:
a mounting bracket;
at least one tray of a first type attached to the mounting bracket, the first type of tray having a first length and an interior volume for storing fiber optic splices; and
at least one tray of a second type attached to the mounting bracket, the second type of tray including:
a base having a second length extending from a proximal end to a distal end, the proximal end of the base being pivotally attached to the mounting bracket by a hinge, and the base further having a width extending between first and second lateral sides of the base; and
a sidewall at least partially surrounding the first and second lateral sides and the distal end, the sidewall and the base defining an interior volume for storing fiber optic splices; and
wherein the first length of the first type of tray is longer than the second length of the second type of tray, and the interior volume of the first type of tray stores a larger quantity of fiber optic splices than the interior volume of the second type of tray; and
wherein the first and second types of trays are pivotally moveable between a stacked position and an unstacked position to provide access to the fiber optic splices stored on the first and second types of trays, respectively.

2. The fiber optic splice organizer of claim 1, wherein the interior volume of the first type of tray has a capacity for storing a first amount of fiber optic splices, wherein the interior volume of the second type of tray has a capacity for storing a second amount of fiber optic splices, and wherein the first and second amounts of fiber optic splices are different.

3. The fiber optic splice organizer of claim 2, further comprising at least one tray of a third type pivotally attached to the mounting bracket, wherein the third type of tray has a third length different from the first and second lengths of the first and second types of trays, and wherein the third type of tray defines an interior volume for storing a third amount of fiber optic splices different from the first and second amounts of fiber optic splices.

4. The fiber optic splice organizer of claim 3, further comprising at least one tray of a fourth type pivotally attached to the mounting bracket, wherein the fourth type of tray has a fourth length different from the first, second, and third lengths of the first, second, and third types of trays, and wherein the fourth type of tray defines an interior volume for storing a fourth amount of fiber optic splices different from the first, second, and third amounts of fiber optic splices.

5. The fiber optic splice organizer of claim 4, further comprising at least one tray of a fifth type pivotally attached to the mounting bracket, wherein the fifth type of tray has a fifth length different from the first, second, third, and fourth lengths, and wherein the fifth type of tray defines an interior volume for storing a fifth amount of fiber optic splices different from the first, second, third, and fourth amounts of fiber optic splices.

6. The fiber optic splice organizer of any of claims 1-5, wherein the first type of tray overlaps the second type of tray when in the stacked position, and the first type of tray is pivotally moveable from the stacked position to the unstacked position to provide access to the second type of tray.

7. The fiber optic splice organizer of any of claims 1-5, wherein the second type of tray overlaps the first type of tray when in the stacked position, and second type of tray is pivotally moveable from the stacked position to the unstacked position to provide access to the first type of tray.

8. The fiber optic splice organizer of any of the preceding claims, further comprising a modular extension attachable to a distal end of the first, second, third, fourth, or fifth types of trays to extend the lengths of the first, second, third, fourth, and fifth types of trays.

9. The fiber optic splice organizer of claim 8, wherein the modular extension is attachable to the first, second, third, fourth, and fifth types of trays by slotting one or more tabs at a proximal end of the modular extension into one or more slots on the distal end of the trays.

10. The fiber optic splice organizer of claim 8, wherein when the modular extension is attached to the second type of tray, a combined length of the modular extension and the second type of tray is shorter than, equal to, or longer than the length of the first type of tray.

11. The fiber optic splice organizer of claim 8, wherein the first, second, third, fourth, and fifth types of trays each have sidewalls having a first height, wherein the modular extension has a sidewall having a second height, and wherein the second height is about twice the first height.

12. The fiber optic splice organizer of claim 8, wherein the first, second, third, fourth, and fifth types of trays each have sidewalls having a first height, wherein the modular extension has a sidewall having a second height, and wherein the second height of the modular extension is substantially similar or the same the first height.

13. The fiber optic splice organizer of any of claim 8 or 11, further comprising a second tray of the second type attached to the mounting bracket in a nested space bounded by the sidewall of the modular extension and the sidewall of the first tray of the second type.

14. The fiber optic splice organizer of any of the preceding claims, wherein the sidewalls at the distal ends of the first, second, third, fourth, and fifth types of trays include a label area for securing a label to the first, second, third, fourth, and fifth types of trays.

15. The fiber optic splice organizer of any of claims 8-14, wherein a portion of the sidewall at a distal end of the modular extension includes a label area.

16. The fiber optic splice organizer of any of claims 8-15, wherein the modular extension has an interior volume that provides a storage area for storing fiber optic equipment including connectors, adapters, splitters, and wave division multiplexers.

17. The fiber optic splice organizer of any of claims 8-16, wherein the modular extension includes a cover that is permanently attached or non-permanently attached to enclose an interior volume of the modular extension.

18. The fiber optic splice organizer of claim 16 or 17, wherein the storage area includes a platform having a first row of adapters on a first side of the platform, and having a second row of adapters on an opposite, second side of the platform, and the platform being pivotable about the first and second sides to provide access to the first and second rows of adapters.

19. The fiber optic splice organizer of any of claims 8-18, wherein the modular extension has apertures that extend through a base next to the first and second sides of the platform for providing access to the first and second rows of adapters.

20. The fiber optic splice organizer of any of claims 16-19, wherein the sidewalls at the distal ends of the first, second, third, fourth, and fifth types of trays have at least one opening providing access from an interior volume of the trays to the storage area of the modular extension.

21. The fiber optic splice organizer of any of the preceding claims, wherein the trays of the first, second, third, fourth, and fifth type each include a label area at proximal ends where the trays of the first, second, third, fourth, and fifth type are pivotally attached to the mounting bracket.

22. The fiber optic splice organizer of any of the preceding claims, wherein the trays of the first, second, third, fourth, and fifth type each have at least one cover that encloses an interior volume of the trays, wherein the cover blocks access to the interior volume when in the closed position, and allows access to the interior volume when in the stowed position.

23. The fiber optic splice organizer of claim 22, wherein the at least one cover of the trays includes a first panel attached to a first lateral side of the tray and a second panel attached to a second lateral side of the tray.

24. The fiber optic splice organizer of claim 22 or 23, wherein the first and second panels include one or more attachment members that rotate and slide within one or more attachment members on the first and second lateral sides of the tray to move the first and second panels between the closed and stowed positions while remaining attached to the tray.

25. The fiber optic splice organizer of any of claims 22-24, wherein the attachment members on the first and second lateral sides of the tray define channels having first and second ends that are shaped to correspond to the attachment members of the first and second panels, the first and second ends allowing the first and second panels to be locked in the closed and stowed positions.

26. The fiber optic splice organizer of any of claims 22-25, wherein the one or more attachment members on the first and second lateral sides of the tray allow the first and second panels of the cover to be removed from the trays without requiring the use of any tools.

27. The fiber optic splice organizer of any of claims 22-26, wherein the channels defined by the attachment members on the first and second lateral sides of the tray each include a slot allowing the attachment members on the first and second panels to disengage from the channel, and allowing the first and second panels to be removed from the tray without using any tools.

28. The fiber optic splice organizer of any of claims 22-27, wherein the one or more attachment members on the first and second lateral sides of the tray prevent the first and second panels of the cover from becoming detached from the trays when in the stowed position.

29. A fiber optic splice organizer comprising:
a tray configured for attachment to a mounting bracket and to pivotally move between a stacked position and an unstacked position, the tray including:
a base having a first length extending from a proximal end to a distal end, the proximal end of the base being pivotally attached to the mounting bracket by a hinge, and the base further having a width extending between first and second lateral sides of the base; and
a sidewall at least partially surrounding the first and second lateral sides and the distal end, the sidewall and the base defining an interior volume for storing fiber optic splices; and
a modular extension attached to the distal end of the tray to extend the length of the tray, the modular extension providing a storage area for storing fiber optic equipment.

30. The fiber optic splice organizer of claim 29, wherein a proximal end of the modular extension attaches to the distal end of the tray by slotting one or more tabs at the proximal end of the modular extension into one or more slots on the sidewall of the tray, and snap fitting a tab on the proximal end of the modular extension into a receptacle defined on the distal end of the tray.

31. The fiber optic splice organizer of claim 29 or 30, wherein the sidewall of the tray has a first height, the modular extension has a sidewall having a second height, and the second height of the modular extension being about twice as tall as the first height of the tray.

32. The fiber optic splice organizer of claim 29 or 30, wherein the sidewall of the tray has a first height, the modular extension has a sidewall having a second height, and the second height of the modular extension being substantially similar or the same as the first height of the tray.

33. The fiber optic splice organizer of claim 29, 30 or 32, wherein the modular extension includes a cover that is permanently attached or non-permanently attached to enclose an interior volume of the modular extension.

34. The fiber optic splice organizer of any of claims 29-33, wherein a sidewall at a distal end of the modular extension has a label area for securing a label to the modular extension.

35. The fiber optic splice organizer of any of claims 29-34, wherein the modular extension includes a base, and the sidewall at least partially surrounds the base to define the storage area.

36. The fiber optic splice organizer of any of claims 29-35, wherein the modular extension has an interior volume that provides the storage area for storing fiber optic equipment including connectors, adapters, splitters, and wave division multiplexers.

37. The fiber optic splice organizer of claim 29, wherein the storage area includes a platform having a first row of adapters on a first side, and having a second row of adapters on a second side, and the platform being pivotable about the first and second sides.

38. The fiber optic splice organizer of claim 37, wherein the modular extension has apertures that extend through the base next to the first and second sides of the platform.

39. The fiber optic splice organizer of any of claims 29-38, wherein the sidewall at the distal end of the tray has at least one opening providing access from the interior volume of the tray to the storage area of the modular extension.

40. A fiber optic splice tray comprising:
a base having a length extending from a proximal end to a distal end, and further having a width extending between first and second lateral sides of the base;
a sidewall at least partially surrounding the first and second lateral sides and the distal end, the sidewall and the base defining an interior volume for storing fiber optic splices; and
a label area provided on the sidewall at the distal end of the tray, the label area defining a slot for receiving a label, the slot having one or more friction retention members to retain the label inside the slot as the tray pivots between stacked and unstacked positions.

41. The fiber optic splice tray of claim 40, further comprising a second label area on a hinge of the tray, the hinge configured to pivotally attach the tray to a mounting bracket.

42. A fiber optic splice organizer comprising:
a tray configured for attachment to a mounting bracket and to pivotally move between a stacked position and an unstacked position, the tray including:
a base having a length extending from a proximal end to a distal end, and further having a width extending between first and second lateral sides of the base; and
a sidewall at least partially surrounding the first and second lateral sides and the distal end, the sidewall and the base defining an interior volume for storing fiber optic splices; and
a modular extension attached to the sidewall at the distal end of the tray to extend the length of the tray, the modular extension having a storage area for storing fiber optic equipment, and the storage area including a platform having a first row of adapters on a first side, and the platform having a second row of adapters on a second side, and the platform being pivotable about the first and second sides to provide access to the first and second rows of adapters.

43. The fiber optic splice organizer of claim 42, wherein the modular extension includes apertures that extend through a base next to the first and second sides of the platform.

44. The fiber optic splice organizer of claim 42 or 43, wherein the sidewall at the distal end of the tray has at least one opening providing access from the interior volume of the tray to the storage area of the modular extension.

45. A fiber optic splice tray comprising:
a base having a length extending from a proximal end to a distal end, and further having a width extending between first and second lateral sides of the base;
a hinge attached to the proximal end of the base, the hinge being configured to pivotally attach the tray to a mounting bracket between stacked and unstacked positions;
a sidewall at least partially surrounding the first and second lateral sides and the distal end, the sidewall and the base defining an interior volume for storing fiber optic splices; and
a label area provided on the hinge of the tray.

46. The fiber optic splice tray of claim 45, further comprising a second label area provided on the sidewall at the distal end, the second label area defining a slot for receiving a label, the slot having one or more friction retention members to retain the label inside the slot.

47. A fiber optic splice tray comprising:
a base having a length extending from a proximal end to a distal end, and further having a width extending between first and second lateral sides of the base;
a sidewall at least partially surrounding the first and second lateral sides and the distal end, the sidewall and the base defining an interior volume for storing fiber optic splices; and
a cover attached to the sidewall, wherein the cover blocks access to the interior volume when in a closed position and allows access to the interior volume when in a stowed position, and wherein the cover when in the stowed position is held parallel to a bottom surface of the tray and is prevented from becoming detached from the tray.

48. The fiber optic splice tray of claim 47, wherein the cover includes a first panel attached to the first lateral side of the tray and a second panel attached to the second lateral side of the tray.

49. The fiber optic splice tray of claim 47 or 48, wherein the cover includes one or more attachment members that rotate and slide within one or more attachment members on the first and second lateral sides of the tray to move the cover between the closed and stowed positions.

50. The fiber optic splice tray of any of claims 47-49, wherein the attachment members on the tray define channels having first and second ends that are shaped for allowing the cover to be locked in the closed and stowed positions.

51. The fiber optic splice tray of any of claims 47-50, wherein the attachment members on the tray allow removal of the cover from the tray without using tools.

52. The fiber optic splice tray of any of claims 47-51, wherein the channels defined by the attachment members on the tray each include a slot allowing the attachment members on the cover to disengage the channels for removal of the cover from the tray without using tools.

53. The fiber optic splice tray of any of claims 47-52, wherein the one or more attachment members on the tray prevent the cover from becoming detached from the tray when the cover is moved from the closed position to the stowed position.
